(19) United States
(12) Patent Application Publication
(10) Pub. No.: US 2023/0049091 A1
(43) Pub. Date: Feb. 16, 2023

(54) CATALYST FOR AIR SECONDARY BATTERY, AIR ELECTRODE, AND AIR SECONDARY BATTERY

(71) Applicant: FDK CORPORATION, Tokyo (JP)

(72) Inventors: Shohei Unoki, Tokyo (JP); Takeshi Kajiwara, Tokyo (JP); Minori Inoue, Tokyo (JP); Takahiro Endo, Tokyo (JP); Shigekazu Yasuoka, Tokyo (JP); Yoshikatsu Watanabe, Yamagata (JP)

(21) Appl. No.: 17/813,566

(22) Filed: Jul. 19, 2022

(30) Foreign Application Priority Data
Aug. 16, 2021 (JP) 2021-132213

(51) Int. Cl. H01M 4/48; H01M 4/62

(52) U.S. Cl. CPC H01M 4/48; H01M 4/626; H01M 2004/027

(57) ABSTRACT

A battery includes: an electrode group including an air electrode and a negative electrode that are stacked with a separator interposed therebetween; and a container housing the electrode group together with an alkaline electrolyte liquid. The air electrode includes a catalyst for an air secondary battery, and this catalyst for an air secondary battery includes a pyrochlore bismuth-ruthenium composite oxide having a full width at half maximum of a diffraction peak corresponding to a (222) face obtained by a powder X-ray diffraction method using CuKα rays as X-rays, of 0.350 deg or larger and 0.713 deg or smaller.

### CROSS-REFERENCE TO RELATED APPLICATION(S)

This application claims priority to Japanese Application No. 2021-132213 filed on Aug. 16, 2021, which is incorporated by reference herein in its entirety.

### BACKGROUND

### Technical Field

The present disclosure relates to a catalyst for an air secondary battery, an air electrode including this catalyst for an air secondary battery, and an air secondary battery including this air electrode.

### Description of the Related Art

In recent years, an air battery using oxygen in the atmosphere as a positive electrode active material has attracted attention because of its high energy density, easiness of downsizing and weight-saving. In such an air battery, a zinc-air primary battery is practically used as a power source for a hearing aid.

In addition, an air secondary battery using Li, Zn, Al, Mg, and the like for a negative electrode metal is being investigated as a chargeable air battery, and such an air secondary battery is promising as a novel secondary battery that may exceed an energy density of a lithium-ion secondary battery.

As a kind of such an air secondary battery, known is an air-hydrogen secondary battery using an alkaline aqueous solution for an electrolyte liquid (hereinafter, also referred to as an alkaline electrolyte liquid) and hydrogen for a negative electrode active material (see Japanese Patent Laid-Open No. 2019-179592, for example). Although an air-hydrogen secondary battery represented by one in Japanese Patent Laid-Open No. 2019-179592 uses a hydrogen-storage alloy as a negative electrode metal, the negative electrode active material in the air-hydrogen secondary battery is hydrogen that is stored and released with the above hydrogen-storage alloy, and thereby dissolution and precipitation reactions of the hydrogen-storage alloy itself do not occur with a chemical reaction during charge and discharge of the battery (hereinafter, also referred to as a battery reaction). Therefore, the air-hydrogen secondary battery has merits of free from problems such as occurrence of an internal short circuit due to a dendric precipitation of the negative electrode metal, so-called a dendrite growth and lowering of a battery capacity due to a change in shape.

In the air secondary battery using the alkaline electrolyte liquid, such as the above air-hydrogen secondary battery, the following charge and discharge reactions occur in a positive electrode (hereinafter, also referred to as an air electrode).

Charge (Oxygen evolution reaction): 4OH⁻→O₂+2H₂O+4e³¹ (I)

Discharge (Oxygen reduction reaction): O₂+2H₂O+4e⁻→4OH⁻ (II)

As shown in the reaction formula (I), the air secondary battery generates oxygen in the air electrode during charge. This oxygen passes through a space inside the air electrode to be released to the atmosphere through a part in the air electrode opened to the atmosphere. On the other hand, during discharge, oxygen that is taken in from the atmosphere is reduced as shown in the reaction formula (II) to generate hydroxide ion.

For the air electrode which is a positive electrode of the above air secondary battery, a catalyst that accelerates the above charge and discharge reactions is used. The air secondary battery is desired to have reduced overvoltage in the charge and discharge reactions in the air electrode in order to improve the energy efficiency and increase the output. Thus, regarding a material for the catalyst used for the air electrode, a material effective for reducing the overvoltage is investigated. Examples of a material effective for reducing such an overvoltage include noble metals, metal oxides, and metal complexes. Among such materials, a pyrochlore bismuth-ruthenium composite oxide is promising as the catalyst for the air secondary battery because it has a dual function of oxygen reduction and oxygen evolution and it can reduce the overvoltage during the charge and the overvoltage during the discharge.

The air secondary battery, which is promising for application to various usage, is desired to have further increased output. To further increase the output, particularly a discharge voltage is required to be higher.

### SUMMARY

An aspect of the present disclosure is directed to a catalyst for an air secondary battery, comprising a pyrochlore bismuth-ruthenium composite oxide having a full width at half maximum of a diffraction peak corresponding to a (222) face obtained by a powder X-ray diffraction method using CuKα rays as X-rays, of 0.350 deg or larger and 0.713 deg or smaller.

### BRIEF DESCRIPTION OF THE DRAWINGS

The present disclosure will become more fully understood from the detailed description given hereinafter and the accompanying drawings which are given by way of illustration only, and thus, are not limitative of the present disclosure, and wherein:

FIG. 1 is a sectional view schematically illustrating an air-hydrogen secondary battery according to an embodiment.

FIG. 2 is XRD profiles of catalysts for an air secondary battery according to Examples 1 to 7 and Comparative Example 1.

FIG. 3 is XRD profiles magnified near 2θ=30° in FIG. 2.

FIG. 4 is a graph indicating a relationship between a full width at half maximum of a (222) face and a midpoint of discharge voltage.

### DETAILED DESCRIPTION

An air-hydrogen secondary battery (hereinafter, also referred to as a battery) 2 including an air electrode catalyst for an air secondary battery according to an embodiment will be described below with reference to the drawing.

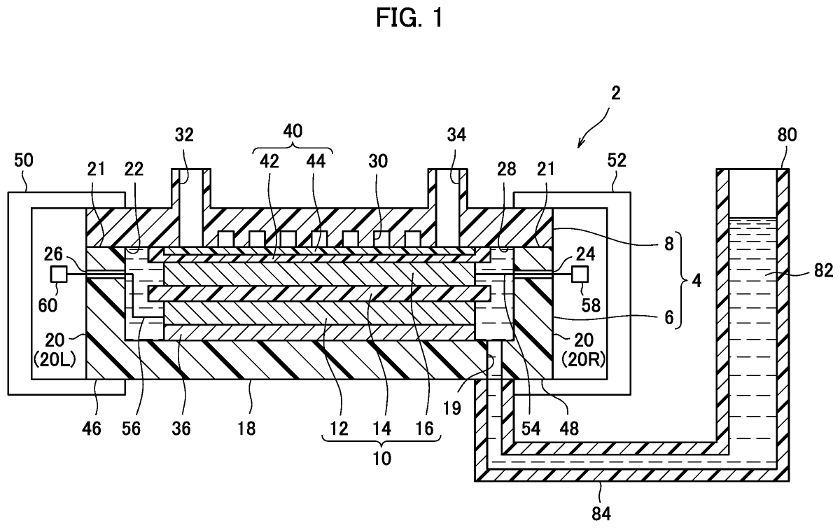

As illustrated in FIG. 1, the battery 2 includes a container 4 and an electrode group 10 housed in the container 4 together with an alkaline electrolyte liquid 82.

The electrode group 10 is formed by stacking a negative electrode 12 and an air electrode (positive electrode) 16 with a separator 14 interposed therebetween.

The negative electrode 12 includes: a negative electrode substrate having a porous structure, many pores, and conductivity; and a negative electrode mixture supported in the above pores and on a surface of the negative electrode substrate. For the above negative electrode substrate, a nickel foam can be used, for example

The negative electrode mixture contains: a hydrogen-storage alloy powder that is an aggregate of hydrogen-storage alloy particles capable of storing and releasing hydrogen as a negative electrode active material; a conductive material; and a binder. For the above conductive material, a graphite powder, a carbon black powder, and the like can be used.

As a hydrogen-storage alloy constituting the hydrogen-storage alloy particles, for example, a rare earth metal-Mg—Ni based hydrogen-storage alloy is preferably used, but the hydrogen-storage alloy is not particularly limited thereto. The composition of this rare earth metal-Mg—Ni based hydrogen-storage alloy may be freely selected, and for example, an alloy represented by the following general formula is preferably used.

General formula: Ln₁₋ₐMgₐNi_{b-c-d}Al_{c}M_{d} (III)

In the general formula (III), Ln represents at least one element selected from the group consisting of La, Ce, Pr, Nd, Pm, Sm, Eu, Gd, Tb, Dy, Ho, Er, Tm, Yb, Lu, Sc, Y, Zr, and Ti; M represents at least one element selected from the group consisting of V, Nb, Ta, Cr, Mo, Mn, Fe, Co, Ga, Zn, Sn, In, Cu, Si, P, and B; and the subscripts a, b, c, and d represent numbers satisfying relationships of 0.01≤a≤0.30, 2.8≤b≤3.9, 0.05≤c≤0.30, and 0≤d≤0.50, respectively.

The hydrogen-storage alloy particle as described above can be obtained as follows, for example.

First, metal raw materials are weighed to be a predetermined composition, and mixed. This mixture is melted under an inert gas atmosphere in, for example, a high-frequency induction melting furnace, and then cooled to form an ingot. The obtained ingot is heated under an inert gas atmosphere to 900 to 1200° C., and subjected to a heat treatment by holding the temperature for 5 to 24 hours to be homogenized. Thereafter, the ingot is crashed and sieved to obtain the hydrogen-storage alloy powder that is the aggregate of the hydrogen-storage alloy particles having a desired particle diameter.

For the binder, sodium polyacrylate, carboxymethyl cellulose, styrene-butadiene rubber, and the like are used, for example.

The negative electrode 12 may be manufactured, for example, as follows.

First, the hydrogen-storage alloy powder that is the aggregate of the hydrogen-storage alloy particles, the conductive material, the binder, and water are kneaded to prepare a negative electrode mixture paste. The obtained negative electrode mixture paste is added into the negative electrode substrate, and then subjected to a drying treatment. After the drying, the negative electrode substrate on which the hydrogen-storage alloy particles and the like are adhered is rolled for increasing an amount of alloy per unit volume, and then cut to obtain the negative electrode 12. This negative electrode 12 has a plate shape as an entirety. Since a negative electrode mixture layer included in the negative electrode 12 is formed with the hydrogen-storage alloy particles, the conductive material particles, and the like, there is space between the particles to form the porous structure as an entirety.

The air electrode 16 includes: a substrate for an air electrode that has a mesh structure and conductivity; and an air electrode mixture layer (positive electrode mixture layer) formed with an air electrode mixture (positive electrode mixture) supported on the above substrate for an air electrode. For the above substrate for an air electrode, a nickel mesh can be used, for example.

The air electrode mixture includes an oxidation-reduction catalyst (catalyst for an air secondary battery), a conductive material, and a binder. In addition, a water-repellent agent is preferably added into the air electrode mixture.

As the oxidation-reduction catalyst, a catalyst having the dual function of oxidation and reduction is used. Such a catalyst having the dual function contributes to reduction of the overvoltage of the battery during both of the charge process and the discharge process. As such an oxidation-reduction catalyst, for example, a pyrochlore bismuth-ruthenium composite oxide is used. This bismuth-ruthenium composite oxide has the dual function of oxygen generation and oxygen reduction.

The bismuth-ruthenium composite oxide has a pyrochlore crystalline structure represented by the composition formula Bi₂₋ₓRu₂O_{7-z} (x satisfies a relationship of 0≤x≤1, and z satisfies a relationship of 0≤z≤1). Used as the bismuth-ruthenium composite oxide used in the present embodiment is a bismuth-ruthenium composite oxide having a full width at half maximum of a diffraction peak corresponding to a (222) face obtained by a powder X-ray diffraction method using CuKα rays as X-rays, of 0.350 deg or larger and 0.713 deg or smaller.

A catalytic reaction of an oxide catalyst typically occurs on a solid surface. Since the surface structure is supported by a bulk crystalline structure, a difference of the crystalline structure often appears sensitively in the battery characteristics. However, an optimal condition between the crystallinity and the battery characteristics diversely varies depending on materials. Thus, the relationship between the crystallinity and the battery characteristics on all the materials is still unclear, and there has been no research example on the relationship between the crystallinity of the bismuth-ruthenium composite oxide and the battery characteristics as far as the present inventor knows. The present inventor has investigated the relationship between the crystalline structure of the bismuth-ruthenium composite oxide and the battery characteristics. As a result, it has been found that a crystallinity of the bismuth-ruthenium composite oxide as the catalyst for an air secondary battery within a specific range can significantly reduce the overvoltage during the discharge reaction of the air secondary battery. The crystallinity in the present embodiment means a degree of rate of an amorphized region in the crystal of the bismuth-ruthenium composite oxide. For example, a higher crystallinity indicates a lower rate of the amorphized region, and a lower crystallinity indicates a larger amorphized area. Used for a means of representing this crystallinity specifically as a value is a magnitude relation of a full width at half maximum of a diffraction peak corresponding to a (222) face obtained by a powder X-ray diffraction method using CuKα rays as X-rays. That is, a smaller full width at half maximum means a higher crystallinity, whereas a larger full width at half maximum means a lower crystallinity and a more amorphized state.

It has been confirmed that the above full width at half maximum of 0.350 deg or larger can yield the effect of reducing the overvoltage during the discharge reaction of the obtained air secondary battery. Meanwhile, it has been confirmed that the above full width at half maximum of larger than 0.713 deg drastically lowers the effect of reducing the overvoltage during the discharge reaction.

The above pyrochlore bismuth-ruthenium composite oxide can be manufactured, for example, as follows.

Bi(NO₃)₃.5H₂O and RuCl₃.3H₂O are prepared. Then, Bi(NO₃)₃.5H₂O and RuCl₃.3H₂O are weighed so that Bi is 0.50 or more and less than 0.80 at a molar ratio based on 1.00 of Ru. The weighed Bi(NO₃)₃.5H₂O and RuCl₃.3H₂O are added to a predetermined solution, and stirred to prepare a mixed aqueous solution of Bi(NO₃)₃.5H₂O and RuCl₃.3H₂O. In this time, examples of the predetermined solution include distilled water and an aqueous solution of dilute nitric acid, and a temperature of these solutions is 60° C. or higher and 90° C. or lower. Then, a 1 mol/L or more and 3 mol/L or less aqueous NaOH solution is added to this mixed aqueous solution to precipitate a precursor (coprecipitation step). After this precursor precipitates, the mixed aqueous solution is stirred. This stirring procedure is performed for 12 hours to 60 hours with an oxygen bubbling. In the mixed aqueous solution during the stirring procedure, a pH is maintained to be 10 to 12, and a temperature is maintained to be 60° C. or higher and 90° C. or lower. After the stirring procedure, the mixed aqueous solution is left to stand for 12 hours to 60 hours. After the standing, the generated precipitate is suction-filtered to be recovered. The recovered precipitate is maintained at 80° C. or higher and 100° C. or lower for evaporating a part of moisture to form a paste. This paste is transferred to an evaporating dish, heated to 100° C. or higher and 150° C. or lower, and maintained at this state for 1 hour or longer and 5 hours or shorter for drying to obtain a dried paste. The obtained dried paste is put on a mortar, grinded with a pestle to obtain a precursor powder.

Then, the precursor powder is subjected to a heat treatment by heating under an air atmosphere to a temperature of 400° C. or higher and 700° C. or lower and by maintaining for 0.5 hours or longer and 4 hours or shorter (calcining step). The powder after the heat treatment is washed by using distilled water at 60° C. or higher and 90° C. or lower, and then subjected to a drying treatment. This drying treatment is performed by maintaining the powder after water washing at 60° C. or higher and 130° C. or lower for 1 hour or longer and 12 hours or shorter. This procedure yields the pyrochlore bismuth-ruthenium composite oxide (Bi₂₋ₓRu₂O_{7-z}).

Next, the obtained bismuth-ruthenium composite oxide is preferably subjected to an acid treatment by immersing in an aqueous nitric acid solution. A specific procedure is as follows.

First, an aqueous nitric acid solution is prepared. A concentration of the aqueous nitric acid solution is preferably 5 mol/L or less. The aqueous nitric acid solution is preferably prepared so that the amount thereof is a proportion of 20 mL per 1 g of the bismuth-ruthenium composite oxide. A temperature of the aqueous nitric acid solution is preferably set to be 20° C. or higher and 25° C. or lower.

Then, the bismuth-ruthenium composite oxide is immersed in the prepared aqueous nitric acid solution, and stirred for 1 hour or longer and 6 hours or shorter. After the stirring for a predetermined time, the bismuth-ruthenium composite oxide in the aqueous nitric acid solution is suction-filtered. The filtered bismuth-ruthenium composite oxide is added in distilled water set at 60° C. or higher and 80° C. or lower to be washed.

The washed bismuth-ruthenium composite oxide is maintained at 60° C. or higher and 130° C. or lower for 1 hour or longer and 12 hours or shorter to be subjected to a drying treatment.

The above procedure yields an acid-treated bismuth-ruthenium composite oxide. Such an acid treatment can remove a byproduct generated in the calcining step of the bismuth-ruthenium composite oxide. The acidic aqueous solution used for the acid treatment is not limited to the aqueous nitric acid solution, and an aqueous hydrochloric acid solution and an aqueous sulfuric acid solution can be used other than the aqueous nitric acid solution. These aqueous hydrochloric acid solution and aqueous sulfuric acid solution can also yield the effect of removing the byproduct similar to the aqueous nitric acid solution.

Examples of a factor that affects the crystallinity of the bismuth-ruthenium composite oxide include the calcining condition in the above calcining step. Specifically, regulating the calcining temperature and the calcination time, which changes the rate of the amorphized region, can control the crystallinity of the bismuth-ruthenium composite oxide.

The bismuth-ruthenium composite oxide obtained as above is mechanically crushed, if necessary, to have a regulated predetermined particle diameter. This procedure can yield a powder of the bismuth-ruthenium composite oxide being of an aggregate of particles having the predetermined particle diameter.

The crushing method is not particularly limited, and for example, the crushing treatment is preferably performed by using a wet bead mill apparatus. When the crushing treatment is performed by using a wet bead mill apparatus, the procedure is as follows. First, ion-exchanged water and a dispersant are added into the bismuth-ruthenium composite oxide and stirred to produce a dispersion. Next, this dispersion is fed into a crushing chamber of the wet bead mill apparatus at a predetermined flow rate by using a pump. Into this crushing chamber, zirconia beads having a predetermined diameter, for example a diameter of 0.1 mm, have been added. Then, the beads to which energy is applied by a centrifugal force generated by driving a stirring mechanism in the crushing chamber at a predetermined speed acts on the bismuth-ruthenium composite oxide particles, which are a material to be crushed. The bismuth-ruthenium composite oxide particles are crushed with this procedure. The dispersion subjected to the crushing treatment as above is discharged from the crushing chamber. In the wet bead mill apparatus, the dispersion discharged from the crushing chamber is fed into the crushing chamber again to perform the crushing treatment again. The procedure including liquid-feeding, crushing, and discharging the dispersion as above is specified as one pass, and by repeating this one pass, the bismuth-ruthenium composite oxide particles can be more finely crushed.

In the wet bead mill apparatus, a degree of crushing the bismuth-ruthenium composite oxide particles can be controlled with the driving speed of the stirring mechanism and with the repeating time of the above one pass. When a strong crushing, which is with a high degree of crushing, is performed, a load is applied to the bismuth-ruthenium composite oxide to increase the amorphized region. That is, the rate of the amorphized region can be changed with the driving speed of the stirring mechanism and with regulating the number of passes; thus, the crystallinity of the bismuth-ruthenium composite oxide can also be controlled with the crushing condition.

Next, the conductive material will be described. The conductive material is used for reducing an internal resistance to increase the output of the air secondary battery, and used as a support for supporting the above oxidation-reduction catalyst.

For such a conductive material (catalyst-supporting conductive material), for example, graphite and nickel are used. In particular, a nickel powder composed of nickel particles is preferably used. An average particle diameter of the above nickel particles is not particularly limited, and preferably a size capable of imparting a desired conductivity to the air electrode.

The above nickel powder is preferably contained at 60 mass % or more in the air electrode mixture. An upper limit of the content of this nickel powder is preferably 80 mass % or less in relation to other component materials in the air electrode mixture. For the nickel powder, carbonyl nickel powder is preferably used. A filament-shaped nickel powder is more preferably used.

The binder acts to bind the component materials of the air electrode mixture. For the binder, a commonly used binder is preferably used.

The water-repellent agent imparts an appropriate water repellency to the air electrode 16. This water-repellent agent is not particularly limited, and used is, for example, a fluororesin such as FEP (perfluoroethylenepropene copolymer), PTFE (polytetrafluoroethylene), PFA (perfluoroalkoxyalkane polymer), ETFE (ethylene-tetrafluoroethylene copolymer), PVDF (polyvinylidene fluoride), and PVF (polyvinyl fluoride). As a preferable fluororesin, PTFE is used. Since having a fibrillation property with a shear force and acting to bind the air electrode mixture, PTFE can also serve as the binder.

The air electrode 16 can be manufactured, for example, as follows.

First, a catalyst powder that is an aggregate of the bismuth-ruthenium composite oxide particles, a conductive material powder that is an aggregate of Ni particles as the conductive material, the water-repellent agent, and water are prepared. Then, these catalyst powder, conductive material powder, water-repellent agent, and water are kneaded to prepare an air electrode mixture paste.

The obtained air electrode mixture paste is formed in a sheet shape by, for example, roller pressing and subjected to a drying treatment at a room temperature of approximately 25° C. This procedure yields an air electrode mixture sheet. Then, the air electrode mixture sheet is crimping-pressed on the nickel mesh (air electrode substrate) to obtain an intermediate product of the air electrode.

Next, the obtained intermediate product is fed into a heat treatment furnace to perform a heat treatment (calcination). This heat treatment is performed in an inert gas atmosphere. As this inert gas, nitrogen gas or argon gas is used, for example. As a condition of the heat treatment, the intermediate product is heated to a temperature of 200° C. or higher and 400° C. or lower to maintain this state for 10 minutes or longer and 40 minutes or shorter. Then, the intermediate product is allowed to be cooled in the heat treatment furnace, and taken out into the atmosphere when the temperature of the intermediate product becomes 150° C. or lower. This procedure yields a heat-treated intermediate product. This heat-treated intermediate product is cut to a predetermined shape to obtain the air electrode 16. This air electrode 16 includes an air electrode mixture layer formed with the air electrode mixture. The air electrode mixture layer formed with such an air electrode mixture has a porous structure including many pores as an entirety, and has an excellent gas diffusivity.

The air electrode 16 and the negative electrode 12, obtained by the above procedures, are stacked with the separator 14 interposed therebetween to form the electrode group 10. This separator 14 is disposed to prevent a short circuit between the air electrode 16 and the negative electrode 12, and an insulative material is used for the separator 14. As the material used for the separator 14, a non-woven fabric made of a polyamide fiber on which a hydrophilic functional group is provided, a non-woven fabric made of a polyolefin fiber such as polyethylene and polypropylene on which a hydrophilic functional group is provided, and the like can be used, for example.

The formed electrode group 10 is housed in the container 4. This container 4 is not particularly limited as long as it can house the electrode group 10 and the alkaline electrolyte liquid, and for example, an acrylic box-shaped container 4 is used. This container 4 includes, for example, a container body 6 and a lid 8, as illustrated in FIG. 1.

The container body 6 has the box shape having a bottom wall 18 and a side wall 20 extending upward from a periphery edge part of the bottom wall 18. A part of the side wall 20 surrounded by an upper end edge 21 is opened. That is, an opening part 22 is provided on the opposite side of the bottom wall 18. On the side wall 20, each through hole is provided on predetermined positions on a right side wall 20R and a left side wall 20L, and these through holes become draw-out apertures 24 and 26 for lead wires, described later.

On the container body 6, an electrolyte liquid storage part 80 is further attached. This electrolyte liquid storage part 80 is a container housing the alkaline electrolyte liquid 82, and attached with, for example, a linking part 84 communicated with a through hole 19 provided on the bottom wall 18. The linking part 84 is a passage of the alkaline electrolyte liquid 82, and communicated between the inside of the container 4 and the electrolyte liquid storage part 80. Since the inside of the container 4 and the electrolyte liquid storage part 80 are communicated with each other, as above, the alkaline electrolyte liquid 82 can move between the inside of the container 4 and the electrolyte liquid storage part 80.

The lid 8 has a plan-viewed shape same as the plan-viewed shape of the container body 6, and covers an upper part of the container body 6 to close the opening part 22. The lid 8 and the upper end edge 21 of the side wall 20 are liquid-tightly sealed.

On the lid 8, a ventilation duct 30 is provided on an inner face part 28 facing the inside of the container body 6. The ventilation duct 30 has an opened part facing the inside of the container body 6, and has one serpentine shape as an entirety. Furthermore, an inlet ventilation hole 32 and an outlet ventilation hole 34 that penetrate in the thickness direction are provided on predetermined positions of the lid 8. The inlet ventilation hole 32 is communicated with one end of the ventilation duct 30, and the outlet ventilation hole 34 is communicated with the other end of the ventilation duct 30. That is, the ventilation duct 30 is opened to the atmosphere through the inlet ventilation hole 32 and the outlet ventilation hole 34. On the inlet ventilation hole 32, a pressure pump, not illustrated, is preferably attached. Driving this pressure pump can feed air into the ventilation duct 30 through the inlet ventilation hole 32.

On the bottom wall 18 of the container body 6, an adjuster 36 is disposed, if necessary. The adjuster 36 is used for positioning in the height direction of the electrode group 10 in the container 4. For the adjuster 36, a nickel foam sheet is used, for example.

The electrode group 10 is disposed on the adjuster 36. In this time, the negative electrode 12 of the electrode group 10 is disposed so as to contact with the adjuster 36.

Meanwhile, a water-repellent ventilation member 40 is disposed on the air electrode 16 side of the electrode group 10 so as to contact with the air electrode 16. This water-repellent ventilation member 40 is a combined material of a PTFE porous film 42 and a non-woven fabric diffusing paper 44. The water-repellent ventilation member 40 has a water repelling effect with PTFE, and allows gas to pass therethrough. The water-repellent ventilation member 40 is interposed between the lid 8 and the air electrode 16, and tightly attached to both of the lid 8 and the air electrode 16. This water-repellent ventilation member 40 has a size that covering an entirety of the ventilation duct 30, inlet ventilation hole 32, and outlet ventilation hole 34 of the lid 8.

The above container body 6 housing the electrode group 10, the adjuster 36, and the water-repellent ventilation member 40 is covered with the lid 8. As schematically illustrated in FIG. 1, the periphery edge parts 46 and 48 of the container 4 (the container body 6 and the lid 8) are sandwiched from upper and lower sides with couplers 50 and 52. Then, a predetermined amount of the alkaline electrolyte liquid 82 is injected through the electrolyte liquid storage part 80 to fill the container 4 with the alkaline electrolyte liquid 82. This procedure forms the battery 2.

As the above alkaline electrolyte liquid 82, a common alkaline electrolyte liquid used for an alkali secondary battery is preferably used, and specifically, an aqueous solution containing at least one of NaOH, KOH, and LiOH as a solute is used.

In the battery 2, the ventilation duct 30 of the lid 8 is opposite to the water-repellent ventilation member 40. Since the water-repellent ventilation member 40 allows gas to pass but blocks moisture, the air electrode 16 is opened to the atmosphere through the water-repellent ventilation member 40, the ventilation duct 30, the inlet ventilation hole 32, and the outlet ventilation hole 34. That is, the air electrode 16 contacts with the atmosphere through the water-repellent ventilation member 40.

In this battery 2, an air electrode lead (positive electrode lead) 54 is electrically connected to the air electrode (positive electrode) 16, and a negative electrode lead 56 is electrically connected to the negative electrode 12. The air electrode lead 54 and negative electrode lead 56, which are schematically illustrated in FIG. 1, are drawn out through draw-out apertures 24 and 26 to the outside of container 4 with keeping the gas tightness and liquid tightness. An air electrode terminal (positive electrode terminal) 58 is provided at a tip of the air electrode lead 54, and a negative electrode terminal 60 is provided at a tip of the negative electrode lead 56. Therefore, the battery 2 inputs and outputs current during charge and discharge using the air electrode terminal 58 and negative electrode terminal 60.

### EXAMPLES

### 1. Manufacture of Battery

### Example 1

### (1) Synthesis of Catalyst for Air Secondary Battery

### 1) Coprecipitation Step

Bi(NO₃)₃.5H₂O and RuCl₃.3H₂O were prepared. Then, Bi(NO₃)₃.5H₂O and RuCl₃.3H₂O were weighed so that Bi was 0.75 at a molar concentration ratio based on 1.00 of Ru. Both of the weighed Bi(NO₃)₃.5H₂O and RuCl₃.3H₂O were added into an aqueous solution of dilute nitric acid at 75° C. and stirred to prepare a mixed aqueous solution of Bi(NO₃)₃.5H₂O and RuCl₃.3H₂O. Then, into the obtained mixed aqueous solution, a 2 mol/L aqueous NaOH solution was gradually added to precipitate a precursor. After this precursor precipitated, the mixed aqueous solution was stirred. This stirring procedure was performed for 48 hours with an oxygen bubbling. During this stirring procedure, a pH of the mixed aqueous solution was maintained at 10.7, and a temperature thereof was maintained at 75° C. After the stirring procedure, the mixed aqueous solution was left to stand for 48 hours. After the standing, the generated precipitate was filtered to be recovered. The recovered precipitate was maintained at 85° C. for evaporating a part of moisture to form a paste. The obtained paste was transferred to an evaporating dish, heated to 120° C., and subjected to a drying treatment by maintaining this state for 3 hours to obtain a dried precursor. The obtained dried precursor was put on a mortar and grinded with a pestle to obtain a powder.

### 2) Calcining Step

The obtained precursor powder was subjected to a calcining treatment by heating at a calcining temperature of 500° C. under an air atmosphere and maintaining this state for 3 hours. The precursor powder after the calcining treatment was washed by using distilled water at 70° C., then suction-filtered, and subjected to a drying treatment by holding 120° C. for 3 hours. The above procedure yielded a pyrochlore bismuth-ruthenium composite oxide (catalyst for an air secondary battery).

### 3) Acid-Treating Step

An aqueous nitric acid solution was prepared so as to be a proportion of 20 mL per 1 g of the bismuth-ruthenium composite oxide powder. This aqueous nitric acid solution and the bismuth-ruthenium composite oxide powder were added into a stirring vessel of a stirrer, and stirred for 1 hour with holding a temperature of the aqueous nitric acid solution to be 25° C. to be subjected to an acid treatment. A concentration of the aqueous nitric acid solution used for the acid treatment was 2 mol/L.

After the stirring, the bismuth-ruthenium composite oxide powder in the aqueous nitric acid solution was suction-filtered to be recovered. The recovered bismuth-ruthenium composite oxide powder was washed with one litter of distilled water heated to 75° C. After the washing, the bismuth-ruthenium composite oxide powder was dried by maintaining under an atmosphere at 120° C. for 3 hours.

The above procedure yielded an acid-treated bismuth-ruthenium composite oxide powder, that is, a powder of an air electrode catalyst for an air secondary battery. In the obtained catalyst for an air secondary battery, as above, performing the acid treatment removed a byproduct generated in the manufacturing process of the bismuth-ruthenium composite oxide.

### 4) Analysis

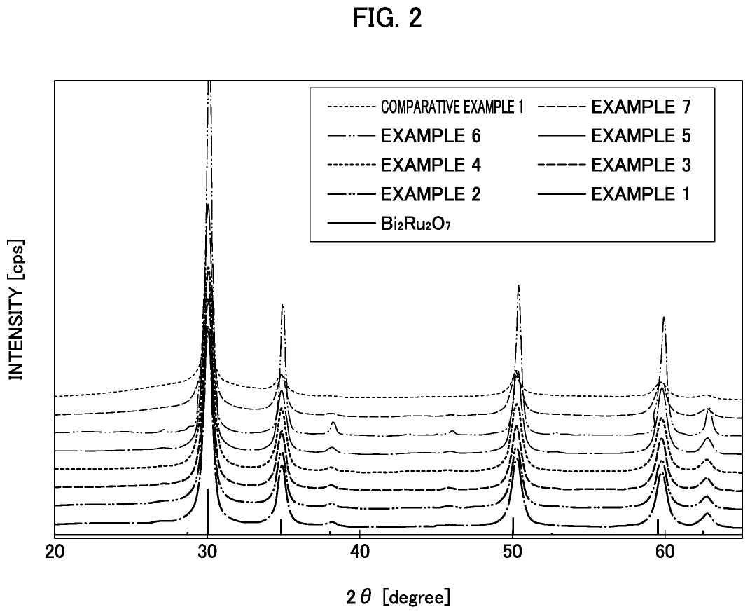

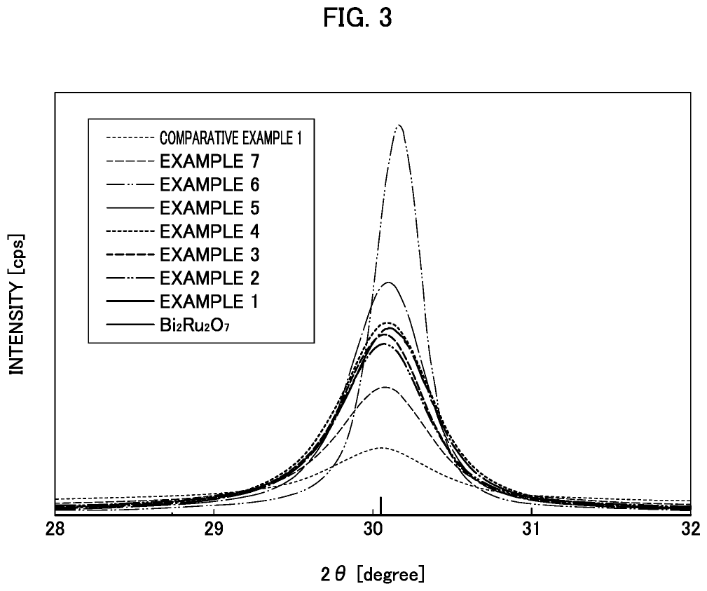

The obtained bismuth-ruthenium composite oxide powder was analyzed with a powder X-ray diffraction method. For this X-ray diffraction (XRD) analysis, a parallel-beam X-ray diffraction analyzer was used. The analysis conditions were as follows: an X-ray source was CuKα; a tube voltage was 40 kV; a tube current was 15 mA; a scanning speed was 1°/min; and a step width was 0.01°. The XRD profiles obtained as a result of the analysis are shown in FIG. 2, and XRD profiles magnified near 2θ=30° in FIG. 2 are shown in FIG. 3. In these FIG. 2 and FIG. 3, the peak positions of Bi₂Ru₂O₇ are also shown. From the obtained XRD profiles, the diffraction peaks are present at positions corresponding the peak positions of Bi₂Ru₂O₇; thus, it was confirmed that the main phase of the calcined powder had a crystalline structure mainly constituted with the Bi₂Ru₂O₇ pyrochlore crystalline structure and a crystalline structure similar thereto.

Furthermore, determined based on the obtained XRD profile was a full width at half maximum of the diffraction peak of the strongest line corresponding to a (222) face that was positioned near 2θ=30°. As a result, the full width at half maximum of the diffraction peak corresponding to a (222) face was 0.676 deg.

### (2) Manufacture of Air Electrode

A nickel powder that was an aggregate of nickel particles was prepared. As this nickel particles, carbonyl nickel particles were used. This carbonyl nickel particles had a mean volume diameter (MV) measured by a laser diffraction/scattering-type particle size distribution measuring device of 3 μm and an apparent density of 0.50 to 0.65 g/mL.

Furthermore, a polytetrafluoroethylene (PTFE) dispersion (31-JR, manufactured by Chemours-Mitsui Fluoroproducts Co., Ltd.) and ion-exchanged water were prepared.

Into the powder of the bismuth-ruthenium composite oxide (catalyst for an air secondary battery) obtained as above, the nickel powder (carbonyl nickel powder), the polytetrafluoroethylene (PTFE) dispersion, and the ion-exchanged water were added to be mixed. In this time, 20 parts by mass of the bismuth-ruthenium composite oxide powder, 70 parts by mass of the carbonyl nickel powder, 10 parts by mass of the PTFE dispersion, and 10 parts by mass of the ion-exchanged water were uniformly mixed at this ratio to manufacture an air electrode mixture paste.

The obtained air electrode mixture paste was formed into a sheet shape with roller pressing, and this sheet-shaped air electrode mixture paste was dried at a room temperature of 25° C. The obtained sheet was crimping-pressed on a nickel mesh with a number of mesh of 60, a wire diameter of 0.08 mm, and an opening ratio of 60%. The above procedure yielded an intermediate product of the air electrode.

Next, the obtained intermediate product was subjected to a heat treatment (calcination). A condition of the heat treatment (calcination) was heating the intermediate product under a nitrogen gas atmosphere at a heat-treatment temperature of 340° C., and holding this temperature for 13 minutes. The heat-treated intermediate product was cut to 40 mm in length and 40 mm in width to obtain an air electrode 16. A thickness of this air electrode 16 was 0.24 mm. In the obtained air electrode 16, an amount of the bismuth-ruthenium composite oxide powder (catalyst for an air secondary battery) was 0.28 g.

### (3) Manufacture of Negative Electrode

Each metal material of Nd, Mg, Ni, and Al was mixed to be a predetermined molar ratio, then fed into a high-frequency induction melting furnace to melt under an argon gas atmosphere, the obtained molten metal was poured into a mold, and cooled to a room temperature at 25° C. to manufacture an ingot.

Then, this ingot was subjected to a heat treatment by holding a temperature of 1000° C. under an argon gas atmosphere for 10 hours, and then cooled to a room temperature at 25° C. After the cooling, the ingot was mechanically crushed under an argon gas atmosphere to obtain a rare earth metal-Mg—Ni based hydrogen-storage alloy powder. On the obtained rare earth metal-Mg—Ni based hydrogen-storage alloy powder, a mean volume diameter (MV) was measured by a laser diffraction/scattering-type particle size distribution measuring device. As a result, the mean volume diameter (MV) was 60 μm.

A composition of this hydrogen-storage alloy powder was analyzed by a high-frequency inductively coupled plasma atomic emission spectroscopy (ICP-AES), and the composition was Nd_{0.89}Mg_{0.11}Ni_{3.33}Al_{0.17}.

Into 100 parts by mass of the obtained hydrogen-storage alloy powder, 0.2 parts by mass of a sodium polyacrylate powder, 0.04 parts by mass of a carboxymethyl cellulose powder, 3.0 part by mass of a styrene-butadiene rubber dispersion, 0.5 parts by mass of a carbon black powder, and 22.4 parts by mass of water were added, and the mixture was kneaded under an environment at 25° C. to prepare a negative electrode mixture paste.

This negative electrode mixture paste was added into a nickel foam sheet with a surface density (basis weight) of approximately 300 g/m² and a thickness of approximately 0.6 mm. Then, the negative electrode mixture paste was dried to obtain a nickel foam sheet filled with the negative electrode mixture. The obtained sheet was rolled for increasing an amount of alloy per unit volume, and then cut to 40 mm in length and 40 mm in width to obtain a negative electrode 12. A thickness of the negative electrode 12 was 0.77 mm. A design capacity of the negative electrode is 2500 mAh.

### (4) Manufacture of Air-Hydrogen Secondary Battery

The obtained air electrode 16 and negative electrode 12 were stacked with a separator 14 interposed therebetween to manufacture an electrode group 10. The separator 14 used for manufacturing this electrode group 10 was formed with a non-woven fabric made of a polypropylene fiber having a sulfone group, and a thickness thereof was 0.1 mm (basis weight of 53 g/m²).

Next, a container body 6 was prepared, and the above electrode group 10 was housed in this container body 6. In this time, a nickel foam sheet as the adjuster 36 was disposed on the bottom wall 18 of the container body 6, and the electrode group 10 was mounted on this adjuster 36. The nickel foam sheet as the adjuster 36 had a square shape with 1 mm in thickness, 40 mm in length, and 40 mm in width.

Next, the water-repellent ventilation member 40 was disposed on the electrode group 10 (on the air electrode 16). The water-repellent ventilation member 40 was formed by combining a PTFE porous film 42 with 45 mm in length, 45 mm in width, and 0.1 mm in thickness, and a non-woven fabric diffusing paper 44 with 40 mm in length, 40 mm in width, and 0.2 mm in thickness.

Next, an opening part 22 of the container body 6 was covered with a lid 8. In this time, the entire area including the ventilation duct 30, inlet ventilation hole 32, and outlet ventilation hole 34 on the inner face part 28 of the lid 8; and the water-repellent ventilation member 40 were tightly attached so that the area was covered with the water-repellent ventilation member 40. The ventilation duct 30 had one serpentine shape as an entirety. A transverse cross section of the ventilation duct 30 was rectangular with 1 mm in length and 1 mm in width. This ventilation duct 30 was opened on the water-repellent ventilation member 40 side.

With the container 4 formed by combining the container body 6 and the lid 8, the periphery edge parts 46 and 48 were sandwiched from upper and lower sides with couplers 50 and 52. At a contacting part between the container body 6 and the lid 8, a packing made of a resin, not illustrated, was disposed to prevent a leakage of the alkaline electrolyte liquid.

Next, a 5 mol/L aqueous KOH solution as the alkaline electrolyte liquid 82 was injected into the electrolyte liquid storage part 80. An amount of the injected aqueous KOH solution in this time was 50 mL.

The battery 2 illustrated in FIG. 1 was manufactured by the above procedure.

An air electrode lead 54 was electrically connected to the air electrode 16, and a negative electrode lead 56 was electrically connected to the negative electrode 12. These air electrode lead 54 and negative electrode lead 56 appropriately extended through draw-out apertures 24 and 26, which were for the leads, to the outside of container 4 with keeping the gas tightness and liquid tightness of the container 4. The air electrode terminal 58 was attached to a tip of the air electrode lead 54, and the negative electrode terminal 60 was attached to a tip of the negative electrode lead 56.

### Example 2

An air-hydrogen secondary battery was manufactured in the same manner as in Example 1 except that the bismuth-ruthenium composite oxide powder obtained by finishing the acid-treating step was subjected to a crushing treatment by using a wet bead mill apparatus.

The step of the above crushing treatment will be described in detail below. First, prepared were ion-exchanged water at an amount of a solid content ratio of 10 wt % to a weight of the bismuth-ruthenium composite oxide powder subjected to the acid-treating step and a dispersant (SN Dispersant 5468, manufactured by San Nopco Ltd.) at an amount of 1 wt % of the weight of the bismuth-ruthenium composite oxide powder similarly subjected to the acid-treating step. Then, the ion-exchanged water and the dispersant prepared as above were added into a predetermined amount of the bismuth-ruthenium composite oxide powder, and mixed them to produce a catalyst dispersion. Next, the obtained catalyst dispersion was fed into a crushing chamber through a feeding port of the crushing chamber of a wet bead mill apparatus (LABSTAR Mini, DMS65, manufactured by Ashizawa Finetech Ltd.) at a predetermined flow rate with a pump. Into this crushing chamber, zirconia beads having a diameter of 0.1 mm were added in advance. Then, the stirring mechanism in the crushing chamber was driven at a peripheral speed of 8 m/s to perform a crushing treatment of a first stage on the bismuth-ruthenium composite oxide particles. Thereafter, the catalyst dispersion discharged through a discharging port of the crushing chamber was fed again into the crushing chamber through the feeding port of the crushing chamber to perform a crushing treatment of a second stage. The procedure including feeding, crushing, and discharging the catalyst dispersion as above was specified as one pass, and this one pass was repeated a total of 20 times (20 passes). Then, the catalyst dispersion was maintained under an atmosphere at 70° C. for 12 hours for drying to obtain a powdery bismuth-ruthenium composite oxide.

In the bismuth-ruthenium composite oxide (catalyst for an air secondary battery) of Example 2, the full width at half maximum of the diffraction peak corresponding to a (222) face was 0.648 deg.

### Example 3

An air-hydrogen secondary battery was manufactured in the same manner as in Example 2 except that the repeating time of feeding, crushing, and discharging the catalyst dispersion was set to 5 (5 passes).

In the bismuth-ruthenium composite oxide (catalyst for an air secondary battery) of Example 3, the full width at half maximum of the diffraction peak corresponding to a (222) face was 0.635 deg.

### Example 4

An air-hydrogen secondary battery was manufactured in the same manner as in Example 1 except that the calcining temperature of the precursor powder was set to 460° C. in the calcining step.

In the bismuth-ruthenium composite oxide (catalyst for an air secondary battery) of Example 4, the full width at half maximum of the diffraction peak corresponding to a (222) face was 0.687 deg.

### Example 5

An air-hydrogen secondary battery was manufactured in the same manner as in Example 1 except that the calcining temperature of the precursor powder was set to 540° C. in the calcining step.

In the bismuth-ruthenium composite oxide (catalyst for an air secondary battery) of Example 5, the full width at half maximum of the diffraction peak corresponding to a (222) face was 0.553 deg.

### Example 6

An air-hydrogen secondary battery was manufactured in the same manner as in Example 1 except that the calcining temperature of the precursor powder was set to 600° C. in the calcining step.

In the bismuth-ruthenium composite oxide (catalyst for an air secondary battery) of Example 6, the full width at half maximum of the diffraction peak corresponding to a (222) face was 0.350 deg.

### Example 7

An air-hydrogen secondary battery was manufactured in the same manner as in Example 2 except that a high-load type apparatus (LABSTAR Mini, LMZ015, manufactured by Ashizawa Finetech Ltd.) was used as the wet bead mill apparatus, the peripheral speed of the stirring mechanism was set to 12 m/s, and the repeating time of feeding, crushing, and discharging the catalyst dispersion was set to 10 (10 passes).

In the bismuth-ruthenium composite oxide (catalyst for an air secondary battery) of Example 7, the full width at half maximum of the diffraction peak corresponding to a (222) face was 0.713 deg.

### Comparative Example 1

An air-hydrogen secondary battery was manufactured in the same manner as in Example 2 except that a high-load type apparatus (LABSTAR Mini, LMZ015, manufactured by Ashizawa Finetech Ltd.) was used as the wet bead mill apparatus, the peripheral speed of the stirring mechanism was set to 12 m/s, and the repeating time of feeding, crushing, and discharging the catalyst dispersion was set to 60 (60 passes).

In the bismuth-ruthenium composite oxide (catalyst for an air secondary battery) of Comparative Example 1, the full width at half maximum of the diffraction peak corresponding to a (222) face was 0.784 deg.

### 2. Evaluation of Air-Hydrogen Secondary Battery

### (1) Evaluation of Battery Characteristics

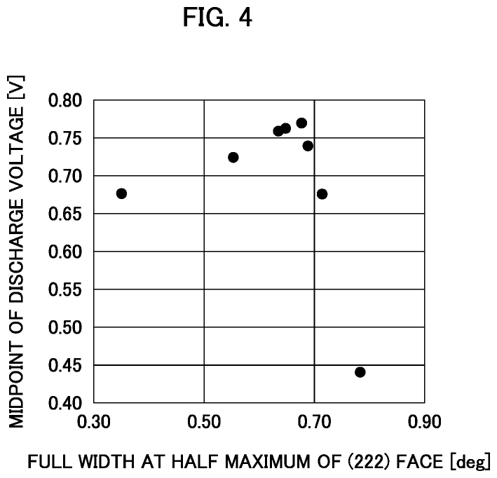

On the air-hydrogen secondary batteries of Examples 1 to 7 and Comparative Example 1, the battery having the above constitution was aged at 60° C. for 12 hours, and then cooled to a room temperature. A capacity of 2000 mAh, which corresponded to 80% of the negative electrode capacity, was specified as 1 It, and the battery was repeatedly charged at 0.1 It×10 hours and discharged at 0.2 It (cut off voltage E.V.=0.4 V). With such a charge-discharge operation, a discharge capacity at a first cycle was determined. In addition, in the first cycle, a battery voltage at which a battery capacity reached a half capacity of the discharge capacity at the first cycle was measured as a midpoint of discharge voltage. The results of the discharge capacity and midpoint of discharge voltage at the first cycle are summarized in Table 1. Table 1 also shows the results of the full width at half maximum obtained by XRD. Furthermore, a relationship between the midpoint of discharge voltage and the full width at half maximum was summarized in FIG. 4.

In the above charge and discharge processes, regardless of the charge and the discharge, air was continuously fed into the ventilation duct 30 at a rate of 33 mL/min by feeding air through the inlet ventilation hole 32 and emitting the air through the outlet ventilation hole 34.

TABLE 1

| | Calcining | Treatment condition | | | Battery characteristics | |
|---|---|---|---|---|---|---|
| | condition | of bead mill | | X-ray diffraction | | Midpoint of |
| | Calcining | Peripheral | Number | Full width at | Discharge | discharge |
| | temperature | speed | of | half maximum | capacity | voltage |
| | [° C.] | [m/s] | passes | [deg] | [mAh] | [V] |
| Example 1 | 500 | — | — | 0.676 | 1973.7 | 0.769 |
| Example 2 | 500 | 8 | 20 | 0.648 | 1945.5 | 0.762 |
| Example 3 | 500 | 8 | 5 | 0.635 | 1949.6 | 0.758 |
| Example 4 | 460 | — | — | 0.687 | 1915.5 | 0.739 |
| Example 5 | 540 | — | — | 0.553 | 1936.4 | 0.723 |
| Example 6 | 600 | — | — | 0.350 | 1918.7 | 0.676 |
| Example 7 | 500 | 12 | 10 | 0.713 | 1426.4 | 0.676 |
| Comparative | 500 | 12 | 60 | 0.784 | 1.3 | 0.441 |
| Example 1 | | | | | | |

### (2) Consideration

From FIG. 2, which shows the XRD profiles of the catalysts for an air secondary battery according to Examples 1 to 7 and Comparative Example 1, and FIG. 3, which shows the XRD profiles magnified near the strongest line of the catalysts for an air secondary battery according to Examples 1 to 7 and Comparative Example 1, the diffraction peak is present at a position corresponding to the position of the Bi₂Ru₂O₇ diffraction peak; thus, any of the catalysts of Examples 1 to 7 and Comparative Example 1 are found to have the crystalline structure mainly constituted with the Bi₂Ru₂O₇ pyrochlore crystalline structure and a crystalline structure similar thereto. In addition, from FIG. 2 and FIG. 3, each of the peak intensity and the full width at half maximum varies sensitively in the bismuth-ruthenium composite oxides of Examples 1 to 7 and Comparative Example 1, which have different manufacturing condition; thus, it is found that the crystallinity significantly varies depending on the manufacturing condition.

From Table 1, which shows the results of the full width at half maximum and the battery characteristics, the batteries of Examples 1 to 7 was able to be stably discharged, but the battery of Comparative Example 1 had a high discharge overvoltage and reached the cut off voltage with hardly discharging. From FIG. 4, which summarizes the relationship between the full width at half maximum and the midpoint of discharge voltage, the full width at half maximum and the midpoint of discharge voltage show a volcano plot: the midpoint of discharge voltage gently increases from 0.350 to 0.676 deg, whereas the midpoint of discharge voltage drastically decreases exceeding 0.676 deg. With 0.784 deg at which the amorphization most progresses, the overvoltage was high and the battery was hardly discharged. From the above, it is clear that the full width at half maximum of the (222) face of the bismuth-ruthenium composite oxide catalyst significantly affects the battery characteristics, and it is found that appropriately amorphizing the crystalline structure can reduce the discharge overvoltage.

The oxygen reduction reaction on the air electrode is considered as a two-electron reaction path or a four-electron reaction path. In a case of the two-electron reaction, oxygen is absorbed on an active site of the catalyst to receive an electron without dissociation, and reacts with water to form a hydrogen peroxide ion and a hydroxide ion. Meanwhile, in a case of the four-electron reaction, only a hydroxide ion is generated and a bond between oxygens is required to be cleaved during the reaction process. It was considered that imparting appropriate amorphousness to the crystalline structure of the bismuth-ruthenium composite oxide catalyst generated a lattice defect such as disturbed regularity of an atomic arrangement on the active site surface, and the change in the electron state accelerated the cleavage of oxygen molecules and decomposition of hydrogen peroxide ions, which were a reaction intermediate.

As above, the catalyst for an air secondary battery according to the present disclosure comprises a pyrochlore bismuth-ruthenium composite oxide having a full width at half maximum of a diffraction peak corresponding to a (222) face obtained by a powder X-ray diffraction method using CuKα rays as X-rays, of 0.350 deg or larger and 0.713 deg or smaller. The catalyst for an air secondary battery having a full width at half maximum of the diffraction peak corresponding to the (222) face obtained by the powder X-ray diffraction method using CuKα rays as X-rays, within a range of 0.350 deg or larger and 0.713 deg or smaller, has a high catalytic activity. Thus, an air secondary battery using such a catalyst for an air secondary battery for an air electrode can reduce the overvoltage during the discharge reaction compared with conventional air secondary batteries. Therefore, the present disclosure can provide a catalyst for an air secondary battery that can raise the discharge voltage compared with conventional ones, an air electrode including this catalyst for an air secondary battery, and an air secondary battery including this air electrode.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A catalyst for an air secondary battery, comprising a pyrochlore bismuth-ruthenium composite oxide having a full width at half maximum of a diffraction peak corresponding to a (222) face obtained by a powder X-ray diffraction method using CuKα rays as X-rays, of 0.350 deg or larger and 0.713 deg or smaller.

2. An air electrode, comprising:
a substrate for an air electrode; and
an air electrode mixture supported on the substrate for an air electrode,
wherein the air electrode mixture includes the catalyst for an air secondary battery according to claim 1 and a catalyst-supporting conductive material supporting the catalyst for an air secondary battery.

3. The air electrode according to claim 2, wherein:
the catalyst-supporting conductive material is nickel.

4. The air electrode according to claim 2, wherein:
the air electrode mixture further includes a water-repellent agent.

5. The air electrode according to claim 4, wherein
the water-repellent agent is a fluororesin.

6. The air electrode according to claim 5, wherein
the fluororesin is polytetrafluoroethylene.

7. An air secondary battery, comprising:
a container;
an electrode group disposed in the container; and
an alkaline electrolyte liquid injected into the container,
wherein:
the electrode group includes an air electrode and a negative electrode that are stacked with a separator interposed therebetween, and
the air electrode is the air electrode according to claim 1.

8. The air secondary battery according to claim 7, wherein:
the negative electrode includes a hydrogen-storage alloy.
